(19) United States
(12) Patent Application Publication
(10) Pub. No.: US 2007/0056232 A1
(43) Pub. Date: Mar. 15, 2007

(54) Connection element for two ends of box-type hollow sections

(76) Inventors: Hans Trautz, Pforzheim (DE); Joachim Rohner, Esslingen (DE)

Correspondence Address: NOTARO AND MICHALOS, 100 DUTCH HILL ROAD, SUITE 110, ORANGEBURG, NY, 10962-2100, US

(21) Appl. No.: 10/575,441

(22) PCT Filed: Oct. 19, 2004
(86) PCT No.: PCT/IB04/03516

§ 371 Date: Apr. 11, 2006

(30) Foreign Application Priority Data
Oct. 22, 2003 (CH) 01797/03

(51) Int. Cl. E06B 7/00

(52) U.S. Cl. 52/204.593

(57) ABSTRACT

A connection element (1) comprises a base plate (4) and two side walls (5, 6). The cross-section of the side walls (5, 6) is curved several times. The side walls (5, 6) have a first cushioning zone (7, 8) and a second cushioning zone (9, 10). This design enables the free ends (28, 29) of the side walls (5, 6) to be cushioned both parallel and perpendicularly to the base plate (4). The claimed connection element (1) is suitable for connecting the ends of metallic or plastic hollow sections.

The invention relates to a connecting element for two end regions of box-shaped hollow profiles, in particular hollow spacer profiles in multi-glazings with a base plate and side walls with resilient retainer elements.

Connecting elements of this type serve the purpose of connecting end regions of box-shaped hollow profiles with one another thereby that the connecting element and the two end regions are emplaced together. The connections may be straight connections or corner connections. Such connecting elements are applied, for example, in insulating and fire protective laminated sheet glass, in which at least two glass sheets are spaced apart from one another. The distance between the two glass sheets is determined by a hollow spacer profile, which is fitted in the proximity of the perimeter of the two glass sheets. Such hollow spacer profiles are produced of metal, for example aluminum, or synthetic material.

A connecting element of this type is disclosed in DE 34 08 600 A1. This element is a connector for hollow profiles, in particular hollow spacer profiles for insulating glass sheets. The described plug connector can be applied as longitudinal connector as well as also corner connector. The hollow spacer profile has substantially a rectangular cross section, the corner regions being in part sloped. However, diverse other cross sectional forms are also known. The connecting element is U-shaped in cross section and is normally die cut from sheet steel and pressed. On the base plate, as well as also the side walls of the connecting element, resilient noses or ears are punched in and projecting, which act as resilient retainer elements. These resilient retainer elements are directed opposite one another on one half of the connecting element each. In each half of the connecting element the retainer elements are directed such that when the connector is inserted they spring into the hollow space of an end of a spacer profile and therewith make possible to plug them together. When pulling the connector and the box-shaped hollow profile apart, the retainer elements dig into the side walls on the inner walls of the hollow spacer profile and ensure a force-fit connection. On each half of the connecting element several such retainer elements can be disposed, and the innermost, seen from the center of the connecting element, retainer element serves also as a stop element during the plugging together of the connector with one end of the hollow spacer profile. This is to prevent that the connecting element can be completely slid into an end of the hollow spacer profile. In this connecting element the front faces are closed. DE 30 37 015 A1 already discloses corresponding connecting elements in which the front faces are open. This open formation permits filling the hollow spaces of the connecting element as well as the hollow spacer profile with fillers, such as for example dehumidification agents or fire protection compounds, in the same process step.

From EP A1 283 689 a further connecting element of this type is known. The connecting element described here is also said to be suitable for corner connections as well as straight connections of hollow spacer profiles in insulation glass sheets. The connecting element also includes retainer elements, die cut into the base area as well as into the lateral surfaces, which are bent outwardly and are resilient.

In the described and known connecting elements, the connecting elements must be formed stiffly in order to ensure the spring effect of the retainer elements. When using hollow spacer profiles of metal, this characteristic normally does not lead to difficulties. However, for some time hollow spacer profiles of synthetic materials are also utilized. When using the known connecting elements, it has now become evident that faults occur repeatedly. One difficulty consists therein that the hollow spacer profiles are damaged or destroyed in the proximity of the inserted connecting elements. Before they are placed between the glass sheets, the hollow spacer profiles are assembled and must subsequently still be transported or moved. The rigid connecting elements lead to the hollow spacer profiles being bent off in the end region of the connecting elements and tear or break. Moreover, the retainer elements, which are disposed on the side walls of the connecting elements, engage in side wall regions of the hollow spacer profiles, which may be exposed to high bending loads. Due to the saw kerf effect of the gouges which are generated when the connecting elements are pushed into the hollow spacer profiles, the hollow spacer profile can burst open under bending loads. Greater fabrication tolerances, such as may occur for example in synthetic hollow profiles or if greater fabrication tolerances in metal hollow profiles are accepted, can frequently not be compensated by the known connecting elements. In this case the force-fit connection between connecting element and the two end regions of the box-shaped hollow spacer profile is not longer ensured in each case.

It is therefore the task of the present invention to provide for box-shaped hollow profiles a connecting element which is capable of compensating for a greater tolerance range of the hollow profile dimensions, is suitable for hollow profiles of metal as well as of synthetic material, and has a similar flexural elasticity as the hollow profile itself. The retainer elements of the connecting elements should furthermore engage regions of the hollow profile on which notches or indentations have no damaging effects.

This task is accomplished through the characteristics defined in patent claim 1. Advantageous further developments of the invention are evident based on the characteristics of the dependent claims.

To accomplish the task the side walls of the connecting elements are developed such that they are profiled in cross section. This profiling can be attained through a simple or multiple curvature of the side walls or through simple or multiple bending or through a combination of curvatures and bendings. The profiling of the two side walls is selected such that a first region of each side wall, which adjoins the base plate of the connecting element, forms a first spring element and a second region of each side wall, which forms the free end region of this side wall, forms a second spring element. The first spring element therein permits movements of the side walls in a direction approximately parallel to the face of the base plate as well as at right angles to the longitudinal axis of the base plate. The second spring element permits movements at least in a direction approximately at right angles to the face of the base plate and to the longitudinal axis of the base plate. This region can, moreover, execute alone or together with the first spring element additional movements, for example in the direction parallel to the face of the base plate of the connecting element. When the connecting element is inserted into a hollow profile, the first regions of the two side walls of the connecting element are at least partially in contact on the two side walls of the hollow profile. The base plate of the connecting element is simultaneously in contact on a base plate of the hollow profile and the free end regions of the second region of each side wall of the connecting element are in contact on the top face of the hollow profile. Due to this disposition according to the invention the connecting element is optimally positioned in the hollow space of the hollow profile. Due to the side walls of the connecting element, resilient parallel as well as at right angles to the base face of the connecting element, an optimal force-fit mounting into the two axial directions transversely to the longitudinal axis is attained. The side walls of the connecting element, springing-in in a relatively wide region, moreover permit adaptation to greater tolerances, i.e. dimensional discrepancies of the hollow space of the hollow profiles, without impairing the quality of the connection between connecting element and hollow profiles. The spring travels are in the range of 1% to 10% of the height or width, respectively, of the connecting element.

An improvement of the connection between connecting element and hollow profiles is attained thereby that the second regions of the two side walls have several recesses open toward the free end region and between these recesses sawtooth-like retainer elements are developed. The saw teeth of the, in the longitudinal direction, left half of the connecting element and the saw teeth of the right half of the connecting element are directed opposite one another. This disposition ensures that the two ends of the two hollow profiles, which are slipped onto the connecting element and abut one another at the center of the connecting element, can be readily slid onto the connecting element; however, the saw teeth directed opposite one another prevent the two hollow profiles from being pulled apart. This [is ensured], on the one hand through the force-fit pressing of the outermost regions of the saw teeth onto the top face of the hollow profile, and, on the other hand, through an at least partial digging of the saw teeth into this top face. These two functions are, in turn, ensured through the strong spring action of the profiled side walls. In addition, on the first region of the side walls, retainer claws directed outwardly are disposed, which entail the advantage that the retaining forces between the side walls of the connecting element and the side walls of the hollow profiles are reinforced. These retainer claws are disposed approximately in the contact area between the side walls of the connecting element and the side walls of the hollow profiles. They are comprised of star-shaped breakthroughs pressed into the side walls of the connecting element, the flaps of these breakthroughs projecting beyond the outer face of the side walls. However, other shapes of retainer claws can also be formed in, which can be produced by punching or pressing.

To ensure the elasticity of the connecting element and to assure that it is approximately adapted to the elasticity of the hollow profiles, the connecting element is produced of a material from the group of high-grade steels and a thickness of the material is selected which is maximally 0.4 mm. This material in this material thickness can be worked and formed well and a material specification can be selected which has the desired elasticity or spring characteristic. Suitable materials are for example chromium nickel steels with a molybdenum addition. In order to attain the desired longitudinal and torsional stability, which agrees with the rigidity values of the hollow profiles, in the base plate of the connecting element at least one reinforcement rib is disposed over a portion of the length of the connecting element. Form and length of this rib depend on the desired rigidity or spring properties of the connecting element. In a manner known per se, several ribs or ribs directed otherwise, can be disposed. A further feasibility of affecting the longitudinal and torsional elasticity of the connecting element is comprised of varying the recesses in the second region of the side walls with respect to their depth in relationship to the total height of the side walls. The depth of these recesses is advantageously selected to be greater than one half of the total height of the side wall.

The connecting element according to the invention is predominantly suitable for straight connections of two end regions of box-shaped hollow profiles. However, in bent form, it can also be utilized in the same manner for corner connections of box-shaped hollow profiles. The connecting element is therein bent in the center in the desired manner in a manner known per se.

In the following the invention will be explained in further detail in conjunction with embodiment examples with reference to the attached drawing. In the drawing depict:

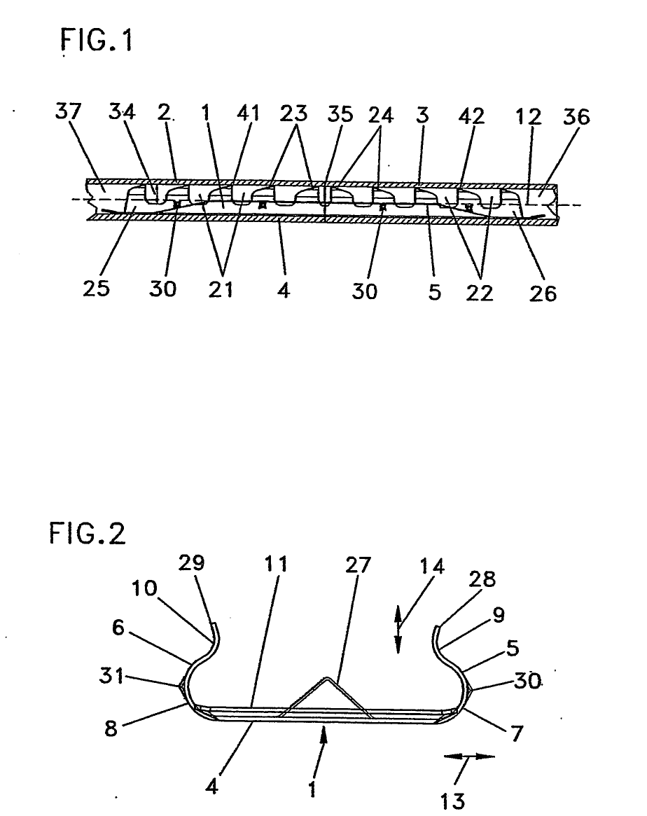

FIG. 1 a longitudinal section through the end regions of two box-shaped hollow profiles with a connecting element according to the invention,

FIG. 2 a cross section through the connecting element according to the invention,

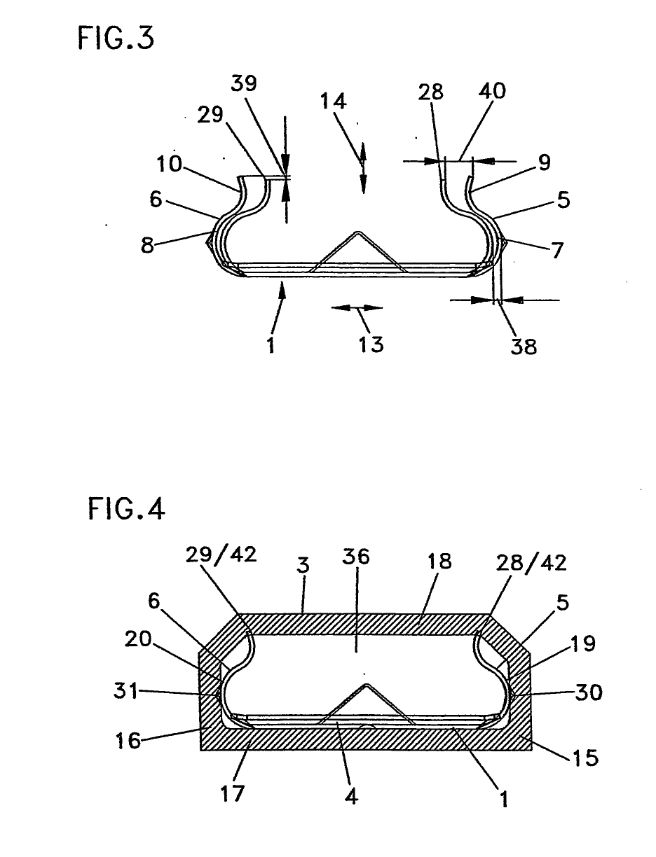

FIG. 3 a cross section through a connecting element with the spring travels of the side walls drawn in,

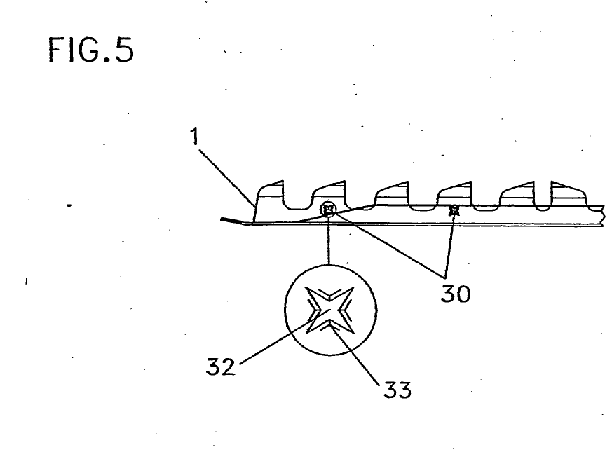

FIG. 4 a cross section through a hollow profile with the connecting element inserted, and

FIG. 5 a partial view of the connecting element with an enlarged view of the lateral retainer claws.

FIG. 1 shows two end regions of two box-shaped hollow profiles 2, 3 which abut one another at a joint 35 on the front face. The two hollow profiles 2, 3 are connected by means of a connecting element 1 according to the invention which engages into the two hollow spaces 36, 37 of the two hollow profiles 2, 3 and positions the two profiles 2, 3 with respect to one another. As is evident in FIG. 2, the connecting element 1 is comprised of a base plate 4 and two profiled side walls 5, 6. The two side walls 5, 6 comprise two regions 7, 9, and 8, 10, respectively. The first region 7, 8 of the two side walls 5, 6 adjoins the base plate 4 and the two second regions 9, 10 of the two side walls 5, 6 form the free end regions of the two side walls 5, 6 with the free ends 28, 29. In the depicted example the profiling of the cross section of the two side walls 5, 6 has a wave-shaped form, which is generated by two circular arcs directed opposite one another. The first region 7, 8 of the two side walls 5, 6 is curved outwardly and, in the depicted example, has for example a radius of 1.5 mm at a total width of the connecting element 1 of approximately 14 mm. The second region 9, 10 of the two side walls 5, 6 has an opposite curvature with a radius of approximately 1 mm. The two curvatures transition one into the other and the two regions 7, 8 and 9, 10, respectively, of the two side walls 5, 6 also mate and can overlap. The connecting element 1, which is shown in FIGS. 1 and 2, has in this example a height of approximately 5 mm. The width and the height of the connecting element 1 as well as the profiling of the two side walls 5, 6 depends on the cross sectional shape of the box-shaped hollow profiles 2, 3. These dimensions can vary over a wide range and are determined by the hollow profile utilized and known per se. The profiling of the cross section of the two side walls 5, 6 can take place through multiple curvatures and/or bendings. What is significant in the choice of this profiling is that the first and second regions 7, 8 and 9, 10, respectively, of the two side walls 5, 6 yield the desired spring elements according to the invention. The doubly curved profile depicted in FIG. 2 results in an especially functional spring action and can be readily produced. The two first regions 7, 8 of the two side walls 5, 6 form spring elements, which make possible the movements of the side walls in the direction of arrows 13 approximately parallel to the face 11 of the base plate 4 as well as approximately at right angles to the longitudinal axis 12 of the connecting element 1. The second regions 9, 10 of the two side walls 5, 6 form a spring element which makes possible movements at least in the direction of arrow 14, i.e. approximately at right angles to the face 11 of base 6 plate 4 and to the longitudinal axis 12 of the connecting element 1. Through the cooperation of the two spring elements the free ends 28, 29 of the two side walls 5, 6 move in the direction of arrow 13 as well as also of arrow 14. The spring travels, which are available to the two side walls 5, 6, permit the adaptation to relatively wide tolerance ranges of the interior dimensions of hollow spaces 36, 37 of the two hollow profiles 2, 3. This [adaptation] is feasible in the direction of the width as well as also the height of the connecting element 1, or of the hollow profiles 2, 3. These spring travels are therein normally selected in a range between 1% to 10% of the width or height, respectively, of the connecting element 1.

In order to adapt the rigidity and elasticity of the connecting element 1 to the resistance to bending of the two hollow profiles 2, 3, the connecting element 1 has in the direction of the longitudinal axis 12 in the center region of the base plate 4 a reinforcement rib 27. The dimensions of this reinforcement rib 27 are determined in known manner and other forms can also be employed. In the two side walls 5, 6 are additionally disposed recesses 21, 22, which are open toward the free ends 28, 29 of the side walls 5, 6. These recesses 21, 22 determine, on the one hand, the bending property of the connecting element 1 transversely to the longitudinal axis 12 and form, on the other hand, the interspaces between saw teeth 23, 24, which are also portions of the side walls 5, 6. The saw teeth 23 of the left half 25 of the connecting element 1 are directed toward the joint 35 and the saw teeth 24 of the right half 26 of the connecting element 1 in the opposite direction, also toward this joint 35. The depth 34 of the recesses 21, 22 in the second region 9, 10 of the side walls 5, 6 is selected such that it is greater than one half of the total height of the side walls 5, 6.

FIG. 3 shows the connecting element 1 in a cross section, the side walls 5, 6 being depicted in the non-installed initial position as well as also in the sprung-in installation position. It is evident that the spring element, which is formed by the first region 7, 8 of the two side walls 5, 6, is displaced by a spring travel 38 in the direction of arrow 13. The second regions 9, 10 of the two side walls 5, 6 form a spring element, which permits at least the springing-in about the spring travel 39 in the direction of arrows 14. The cooperation of the two spring elements, which are formed by the first regions 7, 8 and the second regions 9, 10, respectively, of the side walls 5, 6, bring about a combination of the springing-in of the free ends 28, 29 of the two side walls 5, 6. This combination causes a superposition of the spring travels 38, 39 such that these free ends 28 are displaced in the direction of arrows 13 about the spring travel 40 and in the direction of arrows 14 about the spring travel 39.

FIG. 4 represents a cross section through the hollow profile 3 with inserted connecting element 1. When inserting the connecting element 1 into the hollow space 36 of the hollow profile 3 the side walls 5, 6 are elastically deformed in the regions of the spring travels 38, 39 and 40 depicted in FIG. 3 and assume the position shown in FIG. 4. Subregions 19, 20 of the two side walls 5, 6 are in contact on the side walls 15, 16 of the hollow profile and, through the spring action in the first region 7, 8 of side walls 5, 6, are pressed onto these. The base plate 4 of the connecting element is in contact on the lower broadside 17 of the hollow profile 3. The free ends 28, 29 of the two side walls 5, 6 of the connecting element 1 are pressed through the spring action against the opposite broadside 18 of the hollow profile 3. In doing so the free ends 28, 29 of the side walls 5, 6 or the edges 42 of the saw teeth 24 dig into the inner face of this broadside 18. The hollow profile 2 or 3, depicted in the example, involves a hollow profile of a synthetic material in which the edges 41, 42 of the saw teeth 23, 24 of the connecting element 1 are pressed into the material as a consequence of the spring forces. As additional anchoring means retainer claws 30, 31 are developed at the first regions 7, 8 of the two side walls 5, 6. These retainer claws 30, 31 are also pressed into the material of the side walls 15, 16 of the hollow profiles 2, 3 and, due to the spring action, form, in addition to the force-fit anchoring, a form-fit connection between the connecting element 1 and the two hollow profiles 2, 3.

FIG. 5 shows the retainer claws 30, 31 on the side walls 5, 6 of the connecting element 1 at an enlarged scale. It is herefrom evident that the retainer claws 30, 31 shown here are comprised of breakthroughs 32, which are generated with a tetragonal tool. As a consequence of the shape of this tool, these breakthroughs 32 receive a star-shaped form with four flaps 33, which are pressed outwardly and project beyond the outer face of the side walls 5, 6. Such breakthroughs 32 can also have a different shape, for which purpose a differently shaped tool is utilized. The penetration depth of the flaps 33, which dig into the side walls 15, 16 of the hollow profiles 3, 4, can be precisely determined, since it, on the one hand, is determined by the spring force of the side walls 5, 6 and, on the other hand, the maximum penetration depth is determined through the subregions 19, 20 of the side wails 5, 6, which are in contact on the side walls 15, 16 of the hollow profiles 2, 3.

With the aid of the profiling of the cross section of the two side walls 5, 6 of the connecting element 1, an optimal adaptation to the cross section form of the hollow space 36, 37 of the hollow profiles 2, 3 is feasible. The retainer elements on the connecting element 1, which are formed by the retainer claws 30, 31 as well as the edges 41, 42 of the saw teeth 23, 24, can be disposed in a position at which no damaging saw kerf effects of the hollow profiles 2, 3 can occur. They can, moreover, be positioned such that the forces which cause the force-fit connection between connecting element 1 and hollow profiles 2, 3, act optimally between connecting element 1 and hollow profiles 2, 3. The implementation according to the invention of the connecting element 1 permits the adaptation of the geometric form in a wide range such that the range of application of this connecting element 1, with virtually all known hollow profiles 2, 3 which are employed in multiple glazings, is feasible.

1-10. (canceled)

11. Connecting element (1) for two end regions of box-shaped hollow profiles (2, 3), in particular hollow spacer profiles in multiple glazings, with a base plate (4) and side walls (5, 6) with resilient retainer elements (30, 31; 23, 24), characterized in that the side walls (5, 6) are profiled in cross section, the cross sectional profile being multiply curved, in a first region (7, 8), adjoining the base plate (4), of each side wall (5, 6) the cross sectional profile of this region (7, 8) is developed such that it is curved outwardly and the side wall (5, 6) forms a spring element which is deflectable in a direction (13) approximately parallel to the face (11) and at right angles to the longitudinal axis (12) of the base plate (4) and in a second region (9, 10) of each side wall (5, 6) which forms the free end region of the side wall (5, 6) the cross sectional profile of this region (9, 10) is developed such that it is curved inwardly in the opposite direction and this region (9, 10) of the side wall (5, 6) forms a further spring element, which is deflectable at least in a direction (14) approximately at right angles to the face (11) and to the longitudinal axis (12) of the base plate (4) and the free ends (28, 29) of the second regions (9, 10) of the side walls (5, 6) are directed upwardly away from the base plate (4).

12. Connecting element for two end regions of box-shaped hollow profiles as claimed in claim 11, characterized in that the first regions (7, 8) of the two side walls (5, 6) of the connecting element (1), which are curved outwardly and against the side walls (15, 16) of the hollow profile (2, 3), in the installed state are resiliently in contact with Page of a subregion (19, 20) on these side walls (15, 16) of the hollow profile (2, 3).

13. Connecting element for two end regions of box-shaped hollow profiles as claimed in claim 11, characterized in that the second regions (9, 10) of the two side walls (5, 6) comprise in the longitudinal direction of the connecting element several recesses (21, 22) open toward the free end region and disposed between these recesses (21, 22) saw teeth (23, 24), the saw teeth (23) of the, in the longitudinal direction, left half (26) of the connecting element (1) and the saw teeth (24) of the right half (26) of the connecting element (1) being directed opposite one another.

14. Connecting element for two end regions of box-shaped hollow profiles as claimed in claim 11, characterized in that the connecting element (1) is comprised of a material from the group of high-grade steels and the thickness of the material is maximally 0.4 mm.

15. Connecting element for two end regions of box-shaped hollow profiles as claimed in claim 11, characterized in that in the center of the base plate (4) a reinforcement rib (27) is disposed at least over a portion of the length of the connecting element (1).

16. Connecting element for two end regions of box-shaped hollow profiles as claimed in claim 11, characterized in that in the installed state the base plate (4) of the connecting element (1) is in contact on an inner broadside (17) of the hollow profiles (2, 3) and the free ends (28, 29) of the second region (9, 10) of each side wall (5, 6) of the connecting element (1) are resiliently in contact on the opposite broadside (18) of the hollow profiles (2, 3).

17. Connecting element for two end regions of box-shaped hollow profiles as claimed in claim 11, characterized in that on the first region (7, 8) of each side wall (5, 6) are disposed outwardly directed retainer claws (30, 31).

18. Connecting element for two end regions of box-shaped hollow profiles as claimed in claim 17, characterized in that these retainer claws (30, 31) are comprised of star-shaped breakthroughs (32) in the side wall (5, 6), which are pressed from the inside to the outside and whose flaps (33) project beyond the outer face of the side wall (5, 6).

19. Connecting elements for two end regions of box-shaped hollow profiles as claimed in claim 13, characterized in that the depth (34) of the recesses (21, 22) in the second region (9, 10) of the side walls (5, 6) is greater than one half of the total height of the side wall (5, 6).
